(19) United States
(12) Patent Application Publication
(10) Pub. No.: US 2010/0122072 A1
(43) Pub. Date: May 13, 2010

(54) Debugging system, debugging method, debugging control method, and debugging control program

(75) Inventor: Hiroki Yarimizu, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONIC CORPORATION, Kawasaki (JP)

(21) Appl. No.: 12/585,693

(22) Filed: Sep. 22, 2009

(30) Foreign Application Priority Data
Nov. 12, 2008 (JP) 2008-289511

(51) Int. Cl. G06F 9/30

(52) U.S. Cl. 712/227; 712/E09.028

(57) ABSTRACT

A debugging system according to an exemplary embodiment of the present invention includes: a plurality of arithmetic processing units (51, 52) that perform arithmetic processing; a comparison unit (53) that compares outputs from the plurality of arithmetic processing units (51, 52); and a debug processing unit (54) that outputs a stop instruction for stopping operation of the comparison unit (53), to the comparison unit 53, when debug processing is performed on a predetermined arithmetic processing unit among the plurality of arithmetic processing units (51, 52).

### BACKGROUND

1. Field of the Invention

The present invention relates to a debugging system, a debugging method, a debugging control method, and a debugging control program.

2. Description of Related Art

In recent years, there is a demand for adopting a redundant processor, which is composed of a plurality of processors, in an on-vehicle microcomputer for a chassis system related to safety features such as a brake. In a redundant processor system, processors are caused to execute the same instruction, and operation results from the processors are compared with each other to enable detection of a failure of the processors, for example, thereby achieving an improvement in safety. In this case, it is necessary to implement a debug function without impairing operational safety when a redundant function is enabled.

A processor having the debug function can be achieved by mounting a unit having the debug function in the processor. The unit having the debug function is, for example, a debug control unit (DCU).

In this regard, however, when the debug function is implemented in a redundant processor system composed of two processors, each of which is mounted with the DCU, for example, the number of elements is increased.

Meanwhile, when the DCU is mounted in one of the processors, only the processor having the DCU mounted therein executes debugging. This results in a problem that an error indicating a mismatch between the operation results from the two processors is detected. In other words, since the two processors execute the same instruction and it is determined whether the operation results thereof match, unless the DCU has a redundant configuration similar to that of the processor, the following problem is caused. That is, when a break occurs in the debug processing, for example, the operation of the processor having the DCU mounted therein is stopped, while the other processor continues operation, which causes a mismatch between the operation results. As a result, unnecessary error detection is carried out.

Note that Japanese Unexamined Patent Application Publication No. 10-133900 discloses a technique for facilitating a test for a final output and enabling early detection of a failure in a system that operates in synchronization with redundant modules. In the system, an output interface circuit for the modules includes a register for outputting written data from all the modules, and a register for outputting data only from the corresponding module and disregarding the other modules.

SUMMARY

The present inventor has found a problem that, as described in the background section, when debugging is performed only on a particular processor in the redundant processor system, there is a problem that unnecessary error detection is carried out.

A first exemplary aspect of the present invention is a debugging system including: a plurality of arithmetic processing units that perform arithmetic processing; a comparison unit that compares outputs from the plurality of arithmetic processing units; and a debug processing unit that outputs, to the comparison unit, a stop instruction for stopping operation of the comparison unit, when debug processing is performed on a predetermined arithmetic processing unit among the plurality of arithmetic processing units.

A second exemplary aspect of the present invention is a debugging method for a system that performs a plurality of arithmetic processings and performs comparison processing between outputs of the arithmetic processings, the debugging method including: stopping the comparison processing, when debug processing is performed on a predetermined arithmetic processing unit among the plurality of arithmetic processing units; and performing debug processing on the predetermined arithmetic processing.

A third exemplary aspect of the present invention is a debugging control method comprising: setting a breakpoint in arithmetic processing performed in a predetermined arithmetic processing unit among a plurality of arithmetic processing units that perform arithmetic processing; determining, based on the breakpoint, a timing for outputting a stop instruction to a comparison unit from a debug processing unit that outputs a stop instruction for stopping operation of the comparison unit that compares outputs from the plurality of arithmetic processing units; and outputting the timing determined to the debug processing unit.

A fourth exemplary aspect of the present invention is a storage medium having stored thereon a debugging control program for causing a computer to execute the steps of: setting a breakpoint in arithmetic processing performed by a predetermined arithmetic processing unit among a plurality of arithmetic processing units that perform arithmetic processing; determining, based on the breakpoint, a timing for outputting a stop instruction to a comparison unit from a debug processing unit that outputs a stop instruction for stopping operation of the comparison unit that compares outputs from the plurality of arithmetic processing units; and outputting the timing determined to the debug processing unit.

Consequently, even when debugging is performed only on a particular processor in the redundant processor system, the comparison between the outputs from the processors is suppressed, and thus unnecessary error detection can be suppressed.

According to an exemplary embodiment of the present invention, it is possible to provide a debugging system, a debugging method, a debugging control method, and a debugging control program that are capable of suppressing unnecessary error detection.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram schematically showing a debugging system according to a first exemplary embodiment of the present invention;

FIG. 2 is a block diagram showing details of the debugging system according to the first exemplary embodiment of the present invention;

FIG. 3 is a flowchart showing operation of the debugging system according to the first exemplary embodiment of the present invention;

FIG. 4 is a block diagram showing a debugging system according to a second exemplary embodiment of the present invention;

FIG. 5 is a flowchart showing operation of the debugging system according to the second exemplary embodiment of the present invention; and

FIG. 6 is a flowchart showing operation of a debugging system according to a third exemplary embodiment of the present invention.

### DETAILED DESCRIPTION OF THE EXEMPLARY EMBODIMENTS

Specific exemplary embodiments of the present invention will be described in detail below with reference to the accompanying drawings.

### First Exemplary Embodiment

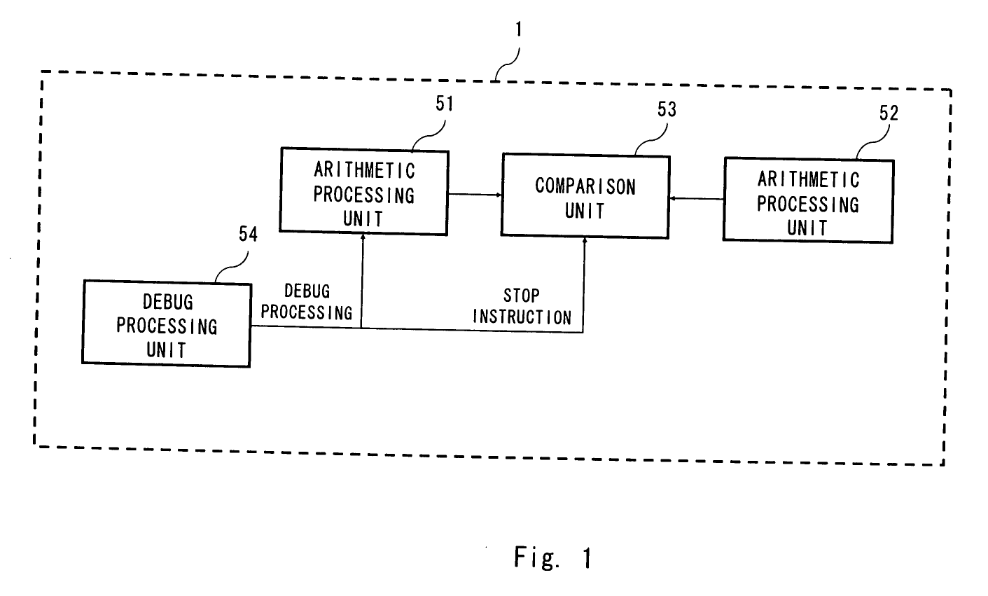

FIG. 1 is a block diagram schematically showing a debugging system according to a first exemplary embodiment of the present invention.

A debugging system 1 includes arithmetic processing units 51 and 52, a comparison unit 53, and a debug processing unit 54. The following description is made assuming that debugging is performed on arithmetic processing executed by the arithmetic processing unit 51.

Each of the arithmetic processing units 51 and 52 is composed of a device capable of performing arithmetic processing, such as a processor. Examples of the processor herein described include a physical processor which is formed on another chip, such as a central processing unit (CPU), and a logic processor which is formed on the same chip, such as a CPU core.

The comparison unit 53 compares an output from the arithmetic processing unit 51 with an output from the arithmetic processing unit 52, and detects a mismatch between the outputs as an error.

The debug processing unit 54 performs debug processing on the arithmetic processing executed by the arithmetic processing unit 51, and performs processing for stopping operation of the comparison unit 53.

During the debug processing on the arithmetic processing executed by the arithmetic processing unit 51, the debug processing unit 54 outputs a stop instruction for stopping operation, to the comparison unit 53.

With this configuration, even when debugging is performed only on a particular arithmetic processing unit, the comparison between the outputs from the arithmetic processing units is suppressed, and thus unnecessary error detection can be suppressed.

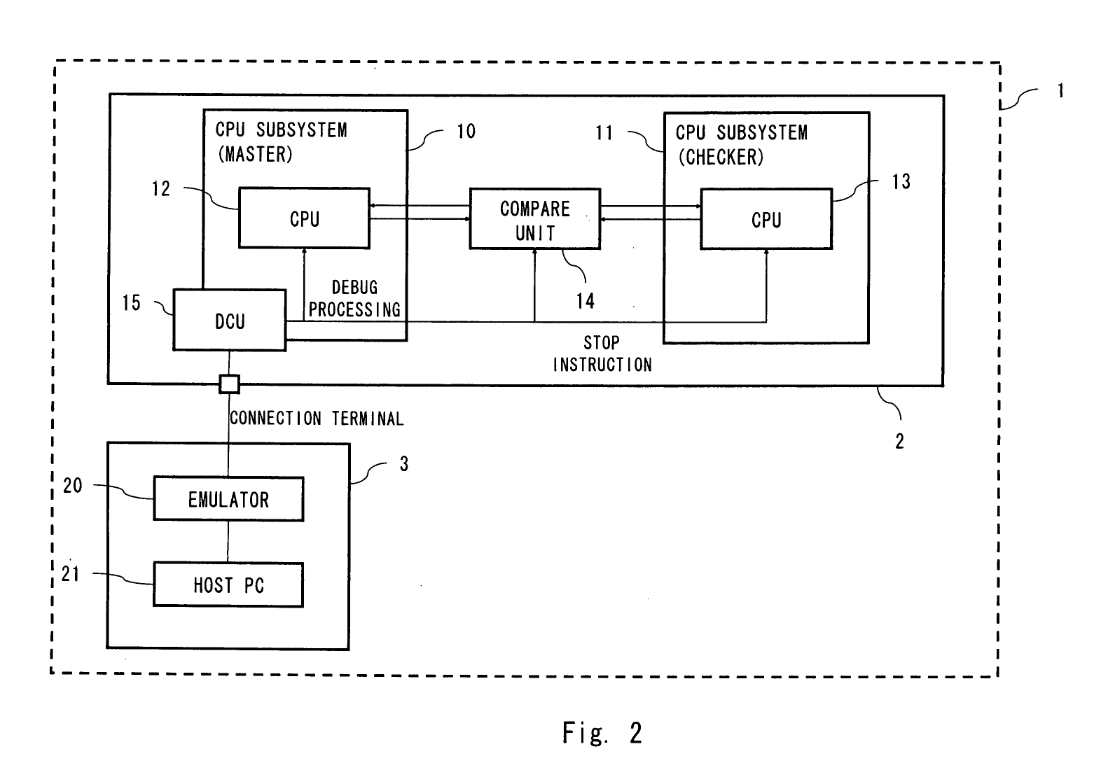

FIG. 2 is a block diagram showing the details of the debugging system according to the first exemplary embodiment of the present invention.

The debugging system 1 includes a redundant processor system 2 and a debugging control system 3.

The redundant processor system 2 includes a CPU subsystem 10, a CPU subsystem 11, and a compare unit 14. The CPU subsystem 10 includes a CPU 12 and a debug control unit (DCU) 15, and the CPU subsystem 11 includes a CPU 13. The CPU subsystems 10 and 11 execute the same instruction, and the outputs from the CPU subsystems 10 and 11 are input to the compare unit 14. Then, the two outputs are compared by the compare unit 14. Further, the redundant processor system 2 includes a storage device (not shown), for example, and is configured to be able to execute a predetermined program. The redundant processor system 2 functions as a redundant operating system, and each of the CPU subsystems 10 and 11 functions as an arithmetic processing unit.

The debugging control system 3 includes an emulator 20 and a host personal computer (PC) 21. The debugging control system 3 is connectable to the redundant processor system 2 through a connection terminal. The connection terminal is, for example, a serial port. Alternatively, any interface capable of transmitting/receiving data may be used. The debugging control system 3 functions as a debug control unit.

Each of the CPUs 12 and 13 includes a CPU core. As described above, this exemplary embodiment may be applied to a multiprocessor in which the CPUs 12 and 13 are formed on different chips. Herein, a description is given of a case where this exemplary embodiment is applied to a multi-core processor.

The compare unit 14 compares an output from the CPU subsystem 10 with an output from the CPU subsystem 11. Upon detecting a mismatch between the outputs, the compare unit 14 outputs an error. The error output process is performed by, for example, generating an interrupt to an OS or application software through interrupt registers included in the CPUs 12 and 13. The compare unit 14 functions as a comparison unit.

The DCU 15 is connected to the debugging control system 3 through the connection terminal. The DCU 15 performs debug processing on the CPU 12 in response to a request from the debugging control system 3. For example, the DCU 15 sets a breakpoint in a program to be executed by the redundant processor system, and acquires various pieces of information contained in the CPU. In addition, the DCU 15 of an exemplary embodiment of the present invention controls the operations of the compare unit 14 and the CPU 13. The DCU 15 functions as a debug processing unit.

The emulator 20 operates as an interface between the DCU 15 and the host PC 21, and transfers various debug commands, which are received from the host PC 21, to the DCU 15. Further, the emulator 20 transfers an output from the DCU 15 to the host PC 21.

The host PC 21 is, for example, an information processor such as a personal computer (PC). The host PC 21 outputs a received debug processing request to the DCU 15 through the emulator 20. Further, the host PC 21 receives an output of a debug processing result from the DCU 15. Each of the emulator 20 and the host PC 21 functions as a debug control unit.

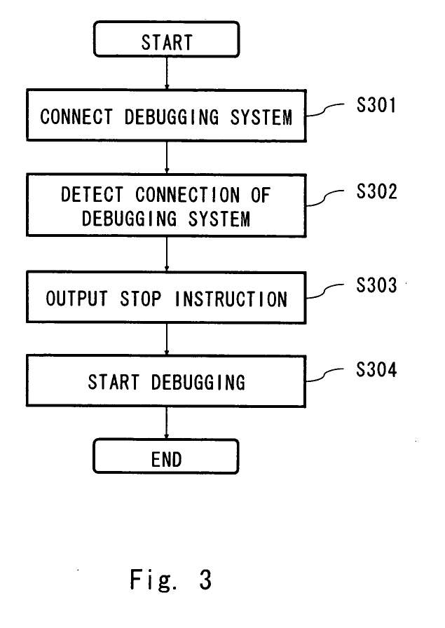

Referring next to the flowchart of FIG. 3, the operation of the debugging system according to the first exemplary embodiment of the present invention will be described.

First, when the debugging control system 3 is connected to the redundant processor system 2 through the connection terminal, a signal indicating that the debugging control system 3 is connected to the redundant processor system 2 becomes active (S301).

The DCU 15 detects the connection of the debugging control system 3 in response to the active signal (S302).

Upon detecting the connection of the debugging control system 3, the DCU 15 outputs the stop instruction for stopping the operations of the CPU 13 and the compare unit 14, to the CPU subsystem 11 and the compare unit 14 (S303). As a result, the operations of the CPU 13 and the compare unit 14 are stopped. For example, the operations thereof are stopped by stopping clock supply or stopping power supply.

After the operations of the CPU 13 and the compare unit 14 are stopped, debug processing for the CPU 12 is started (S304).

While the debugging control system including the emulator and the host PC has been described above as an example, the configuration of the debugging control system is not limited thereto as long as debug processing can be performed by connecting the debugging system to the DCU of the redundant processor system. In this exemplary embodiment, unnecessary error detection is suppressed by stopping the operations of the CPU 13 and the compare unit 14. Alternatively, unnecessary error detection can be suppressed by outputting the stop instruction only to the compare unit 14 to stop the operation of the compare unit 14. Moreover, unnecessary error detection can be suppressed also by stopping the output of the compare unit 14 instead of stopping the operation thereof.

As described above, according to this exemplary embodiment, even when debugging is performed only on a particular processor in the redundant processor system, the comparison between the outputs from the processors is suppressed, and thus unnecessary error detection can be suppressed.

Further, debug processing can be executed with the DCU being mounted only in a particular processor. This eliminates the need of making the debug function redundant, and results in a reduction in the number of elements.

Furthermore, the operation of the processor other than the processor to be subjected to debugging and the operation of the compare unit are stopped only by connecting the debugging control system to the redundant processor system, thereby making it possible to execute the debugging processing. As a result, the operability of the debugging processing is improved, and the debugging processing is facilitated.

Moreover, this exemplary embodiment can be implemented without sacrificing a redundant function. Accordingly, the operational safety is not impaired when the redundant function is enabled.

### Second Exemplary Embodiment

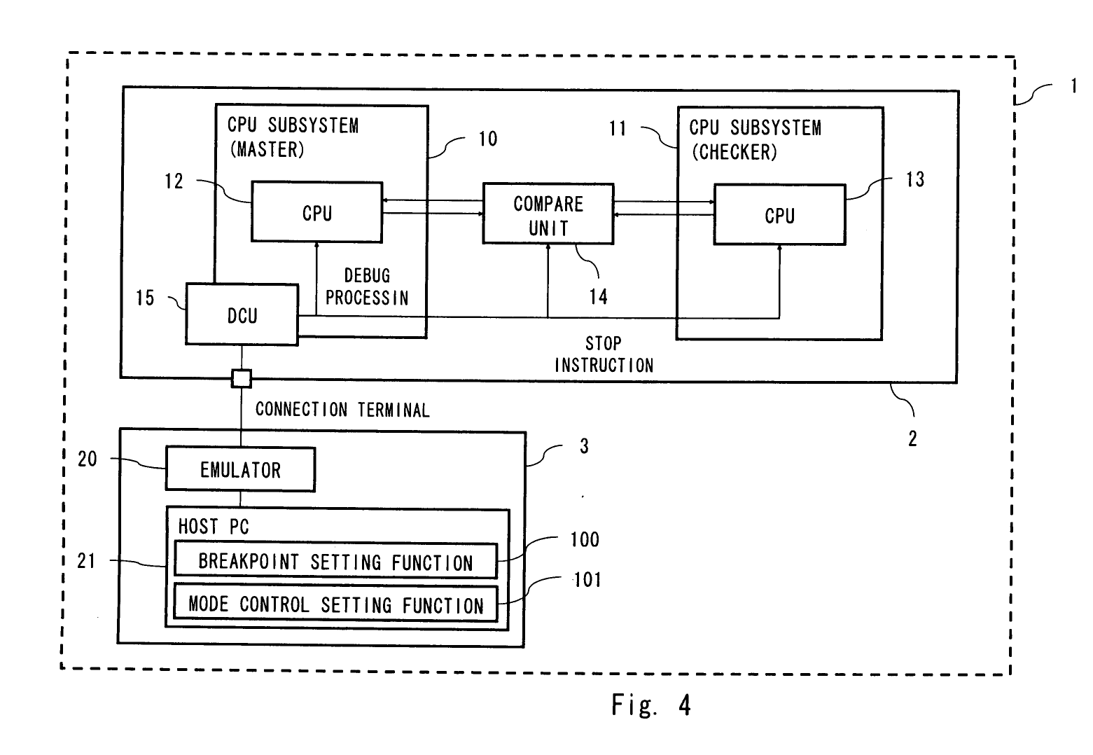

FIG. 4 is a block diagram showing a debugging system according to a second exemplary embodiment of the present invention.

Note that the constituent elements shown in FIG. 4 are similar to those of the first exemplary embodiment, so the description thereof is omitted. This exemplary embodiment differs from the first exemplary embodiment shown in FIG. 2 in that a breakpoint setting function 100 and a mode control setting function 101 are described in detail as functions of the host PC 21.

The breakpoint setting function 10 is a function for setting a breakpoint in a program to be executed by the redundant processor system.

The mode control setting function 101 determines a timing for outputting a stop instruction to each of the compare unit 14 and the CPU subsystem 11 from the DCU 15, based on the breakpoint set by the breakpoint setting function 10.

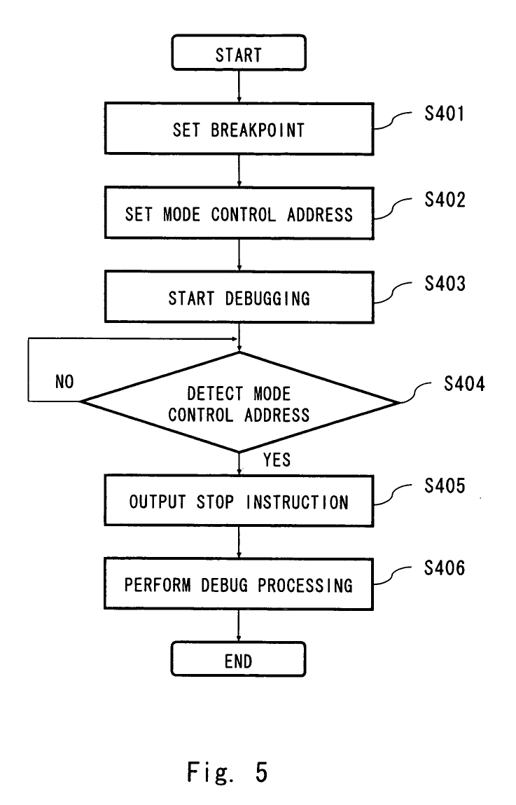

Referring next to the flowchart of FIG. 5, the operation of the debugging system according to the second exemplary embodiment of the present invention will be described.

First, the breakpoint setting function 100 of the host PC 21 sets a breakpoint in a program to be executed by the redundant processor system (S401). For example, the breakpoint is set by designating the address of an instruction contained in the program, the execution of which is to be stopped, as a breakpoint address.

When the breakpoint is set, the mode control setting function 101 sets a mode control address based on the set breakpoint (S402). The address of an instruction to be executed several cycles before the address at which the breakpoint is set is calculated, and the calculated address is set as the mode control address. The host PC 21 outputs the breakpoint address and the mode control address to the DCU 15 through the emulator 20. Then, the DCU 15 receiving the output from the host PC 21 outputs the breakpoint address and the mode control address to the CPU 12.

It is also possible to employ a method of detecting the breakpoint before stopping the operations of the compare unit 14 and the CPU 13. In this case, however, the stop instruction is output to each of the compare unit 14 and the CPU subsystem 11 after the breakpoint is detected, which causes a delay in stopping the operations of the compare unit 14 and the CPU 13. Thus, there is a fear that the compare unit 14 may detect an error. Accordingly, in this exemplary embodiment, the address of the instruction to be executed several clocks before the breakpoint is calculated. Then, at the time when the execution address of a program reaches the calculated address, the stop instruction is output from the DCU 15 to each of the compare unit 14 and the CPU subsystem 11.

While the address of the instruction to be executed several clocks before the breakpoint is used as the mode control address in this exemplary embodiment, the number of clocks is not limited to that illustrated in this exemplary embodiment. Various timings can be used other than the timing at which the compare unit 14 performs error detection.

Next, debug processing is started after the host PC 21 performs other settings relating to the debug processing as needed (S403). When the execution address of the program executed in the CPU 12 reaches the mode control address during the debug processing performed on the redundant processor system 1, the DCU 15 outputs the stop instruction to each of the compare unit 14 and the CPU subsystem 11 (S404, S405). Thus, even when the execution address of the program in the CPU 12 reaches the breakpoint and the operation of the CPU 12 is stopped, the error detection of the compare unit 14 can be suppressed.

When the execution address of the program in the CPU 12 reaches the breakpoint, the operation of the CPU 12 is stopped. As a result, debug processing such as acquisition of various pieces of information contained in the CPU 12 can be carried out (S406).

As described above, according to this exemplary embodiment, even when debugging is performed only on a particular processor in the redundant processor system, the comparison between the outputs from the processors is suppressed, and thus unnecessary error detection can be suppressed.

Further, debug processing can be executed with the DCU being mounted only in a particular processor. This eliminates the need of making the debug function redundant, and results in a reduction in the number of elements.

Furthermore, the operation of the processor other than the processor to be subjected to debugging and the operation of the compare unit are stopped only by setting a breakpoint in a program to be executed by the redundant processor system, thereby making it possible to execute the debugging processing. As a result, the operability of the debugging processing is improved, and the debugging processing is facilitated.

Moreover, this exemplary embodiment can be implemented without sacrificing a redundant function. Accordingly, the operational safety is not impaired when the redundant function is enabled.

### Third Exemplary Embodiment

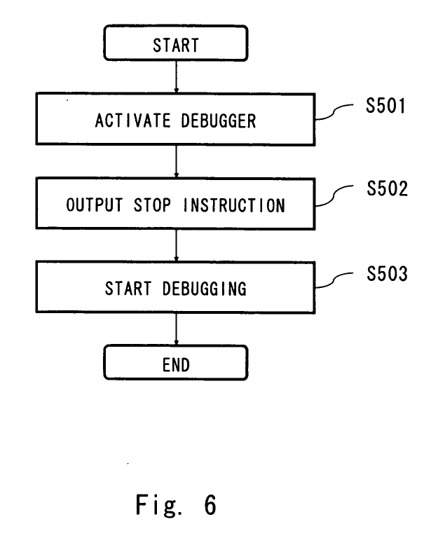

Referring now to the flowchart of FIG. 6, the operation of a debugging system according to a third exemplary embodiment of the present invention will be described.

Note that the overall configuration of the debugging system according to the third exemplary embodiment of the present invention is similar to that shown in FIG. 2, so the description thereof is omitted.

First, the debugging control system 3 is connected to the DCU 15 to activate the debugger in the host PC 21 (S501).

At the timing when the debugger is activated, the stop instruction is output from the host PC 21 to each of the CPU subsystem 11 and the compare unit 14 through the emulator 20 and the DCU 15 (S502). As a result, the operations of the CPU 13 and the compare unit 14 are stopped.

After the operations of the CPU 13 and the compare unit 14 are stopped, the debug processing for the CPU 12 is started (S304).

As described above, according to this exemplary embodiment, even when debugging is performed only on a particular processor, the comparison between the outputs from the processors is suppressed, and thus unnecessary error detection can be suppressed.

Further, debug processing can be executed with the DCU being mounted only in a particular processor. This eliminates the need of making the debug function redundant, and results in a reduction in the number of elements.

Furthermore, the operation of the processor other than the processor to be subjected to debugging and the operation of the compare unit are stopped only by activating the debugger in the debugging control system, thereby making it possible to execute the debugging processing. As a result, the operability of the debugging processing is improved, and the debugging processing is facilitated.

Moreover, this exemplary embodiment can be implemented without sacrificing a redundant function. Accordingly, the operational safety is not impaired when the redundant function is enabled.

Note that the debugging control system according to exemplary embodiments of the present invention can also be configured by supplying a storage medium, which stores a program for implementing the functions according to exemplary embodiments of the present invention, to a system or a device, and by causing a computer, a CPU, or an MPU included in the system or device to execute the program.

The program can be stored in various types of storage media, and can be transmitted via communication media. Examples of the storage media include flexible disks, hard disks, magnetic disks, magnet-optical disks, CD-ROMs, DVDs, ROM cartridges, RAM memory cartridges with battery backup, flash memory cartridges, and non-volatile RAM cartridges. Examples of the communication media include wired communication media such as a telephone line, wireless communication media such as a microwave line, and the Internet.

While the functions according to the above exemplary embodiments can be implemented by causing a computer to execute a program for implementing the functions according to the exemplary embodiments, the functions according to the exemplary embodiments can also be implemented in the following case. That is, the functions according to the exemplary embodiments can be implemented in cooperation with an operating system (OS) or application software running on a computer, in response to an instruction from the program.

Moreover, the functions according to the exemplary embodiments can also be implemented when all or part of the processing for the program is executed by a function extension board inserted into a computer or a function extension unit connected to a computer.

The first to third exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A debugging system comprising:
a plurality of arithmetic processing units that perform arithmetic processing;
a comparison unit that compares outputs from the plurality of arithmetic processing units; and
a debug processing unit that outputs, to the comparison unit, a stop instruction for stopping operation of the comparison unit, when debug processing is performed on a predetermined arithmetic processing unit among the plurality of arithmetic processing units.

2. The debugging system according to claim 1, further comprising a debug control unit that outputs a debug processing request to the debug processing unit,
wherein the debug processing unit outputs the stop instruction when the debug control unit is connected to the debug processing unit.

3. The debugging system according to claim 1, further comprising a debug control unit that outputs a debug processing request to the debug processing unit, wherein
the debug control unit determines a timing for outputting the stop instruction, based on a breakpoint set in arithmetic processing performed by the predetermined arithmetic processing unit, and
the debug processing unit outputs the stop instruction at the timing determined by the debug control unit.

4. The debugging system according to claim 1, further comprising a debug control unit that outputs a debug processing request to the debug processing unit,
wherein the debug processing unit outputs the stop instruction when a debugger is activated in the debug control unit.

5. The debugging system according to claim 1, wherein the debug processing unit outputs the stop instruction also to arithmetic processing units other than the predetermined arithmetic processing unit.

6. The debugging system according to claim 1, wherein the stop instruction causes the comparison unit to stop outputting a comparison result.

7. The debugging system according to claim 1, wherein each of the arithmetic processing units comprises a processor.

8. A debugging method for a system that performs a plurality of arithmetic processings and performs comparison processing between outputs of the arithmetic processings, the debugging method comprising:
stopping the comparison processing, when debug processing is performed on a predetermined arithmetic processing unit among the plurality of arithmetic processing units; and
performing debug processing on the predetermined arithmetic processing.

9. A debugging control method comprising:
setting a breakpoint in arithmetic processing performed in a predetermined arithmetic processing unit among a plurality of arithmetic processing units that perform arithmetic processing;
determining, based on the breakpoint, a timing for outputting a stop instruction to a comparison unit from a debug processing unit that outputs a stop instruction for stopping operation of the comparison unit that compares outputs from the plurality of arithmetic processing units; and
outputting the timing determined to the debug processing unit.

10. A storage medium having stored thereon a debugging control program for causing a computer to execute the steps of:
setting a breakpoint in arithmetic processing performed by a predetermined arithmetic processing unit among a plurality of arithmetic processing units that perform arithmetic processing;
determining, based on the breakpoint, a timing for outputting a stop instruction to a comparison unit from a debug processing unit that outputs a stop instruction for stopping operation of the comparison unit that compares outputs from the plurality of arithmetic processing units; and
outputting the timing determined to the debug processing unit.
